(19) United States
(12) Patent Application Publication
(10) Pub. No.: US 2005/0107100 A1
(43) Pub. Date: May 19, 2005

(54) Method of modifying parameters of user terminal, radio system and user terminal

(76) Inventors: Patrik Gustafsson, Espoo (FI); Jouni Kangas, Espoo (FI)

Correspondence Address: CRAWFORD MAUNU PLLC, 1270 NORTHLAND DRIVE, SUITE 390, ST. PAUL, MN, 55120, US

(21) Appl. No.: 10/714,418

(22) Filed: Nov. 14, 2003

(51) Int. Cl. H04Q 7/20

(52) U.S. Cl. 455/466; 455/433; 455/412.1; 455/419

(57) ABSTRACT

There is provided a method of modifying parameters of a user terminal in a radio system and radio system. The method comprises the step of generating a USSD (Unstructured Supplementary. Service Data) message comprising data relating to parameters of the user terminal. The method further comprises the steps of transmitting the USSD message from the user terminal to a home location register of the radio system, forwarding the received USSD message from the home location register via a USSD gateway to an application server, and modifying the parameters of the user terminal based on the data relating to the parameters of the user terminal.

### BACKGROUND OF THE INVENTION

1. Field of the Invention

The invention relates to a method for modifying parameters of a user terminal in a radio system, to a radio system and to a user terminal.

2. Description of the Related Art

In known radio systems, such as in GSM (Global System for Mobile Communications)/GPRS (General Packet Radio Service) systems, information about user terminals in the radio system may be communicated to the network by using IMEI (international mobile equipment identity) identifiers, for example. For example, a user terminal may need to update the current status of the device with respect to the capabilities with regard to peers and servers of the radio system. Also, other types of signalling information, such as information related to device configuration, need to be communicated between user terminals and servers.

When the user terminal is switched on, IMEI is communicated to a HLR (Home Location Register) of the radio system, for example, and then to other servers that perform mapping between the IMEI range and a static device profile, that is, the default capabilities of a certain user terminal. However, IMEI provides only static information while dynamic information that would be able to picture the current state of the user terminals is needed. Thus, it is possible that many operations may take place because the servers are unaware that the user terminal capabilities are different than assumed.

One possibility to act as a bearer for the status registration would be GPRS. However, often when the user of the device changes something with this device, such as attaches or detaches an accessory, or just switches the device on, there is not an immediate need to actually connect to a GPRS network. Further, connecting to the GPRS network may induce costs, as does data transfer in the GPRS network. Many applications would benefit from a real-time mechanism to update the status and capabilities of user terminals.

### SUMMARY OF THE INVENTION

According to an aspect of the invention, there is provided a method of modifying parameters of a user terminal in a radio system. The method comprises the steps of generating a USSD (Unstructured SupplementaryService Data) message comprising data relating to parameters of the user terminal, transmitting the USSD message from the user terminal to a home location register of the radio system, forwarding the received USSD message from the home location register via a USSD gateway to an application server, and modifying the parameters of the user terminal based on the data relating to the parameters of the user terminal.

According to an embodiment of the invention, there is provided a radio system comprising a user terminal, a home location register, a USSD gateway and an application server. The user terminal is configured to generate a USSD (Unstructured Supplementary Service Data) message comprising data relating to parameters of the user terminal and to transmit the USSD message to the home location register. The home location register is configured to forward the USSD message via the USSD gateway to the application server, and the application server is configured to process the USSD message for modifying the parameters of the user terminal.

According to another embodiment of the invention, there is provided a user terminal in a radio system. The user terminal comprises generating means for generating a USSD (Unstructured Supplementary Service Data) message, the USSD message comprising data relating to parameters of the user terminal, transceiver means for transmitting the USSD message to an application server of the radio system and for receiving feedback from the application server, and modifying means for modifying the parameters of the user terminal.

The embodiments of the invention provide several advantages. The method is efficient and easy to use. Very fast communication be-ween the user terminal and an application is achieved. The invention also suits user terminals with limited data capabilities. The method is also well protected. The capabilities of the user terminal may be easily increased or decreased.

### BRIEF DESCRIPTION OF THE DRAWINGS

In the following, the invention will be described in greater detail with reference to preferred embodiments and the accompanying drawings, in which

FIG. 1 shows an example of the structure of a radio system;

FIG. 2 shows an example of a user terminal, and

FIGS. 3 and 4 show examples of a method of modifying parameters of a user terminal in a radio system.

### DETAILED DESCRIPTION OF THE PREFERRED EMBODIMENTS

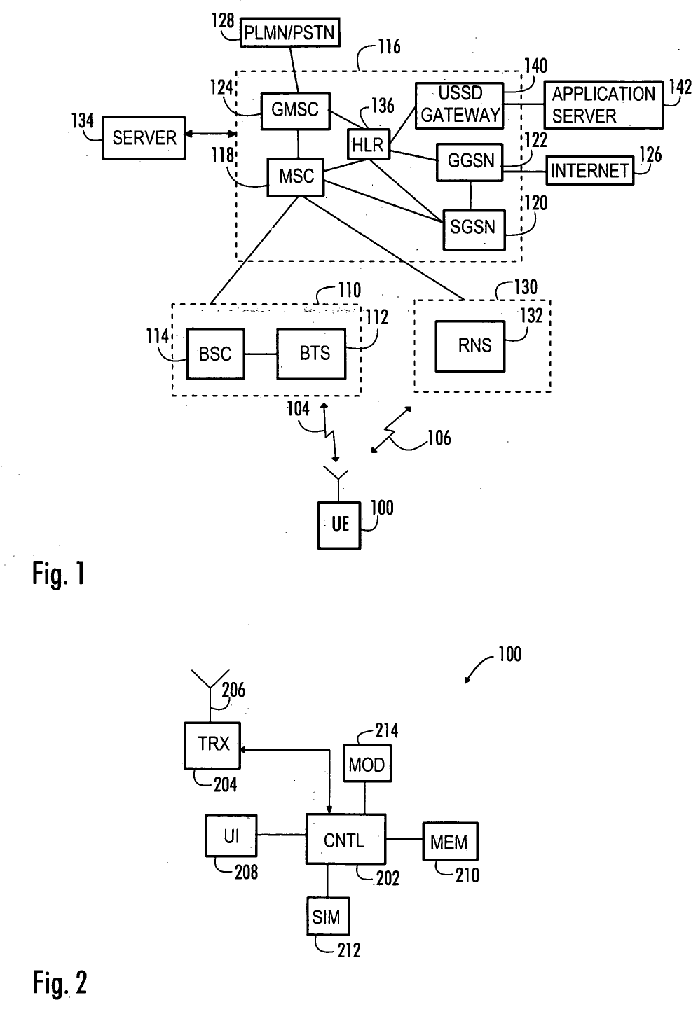

The embodiments of the invention are applicable in user terminals, such as in mobile stations used as a terminal in telecommunications systems comprising one or more base stations and terminals communicating with the base stations. With reference to FIG. 1, examine an example of a structure of a radio system to which the preferred embodiments of the invention can be applied. The structure and functions of the elements of the radio system are not described in detail because they are generally known. The radio system in FIG. 1 is arranged to set up connections 104, 106 between different user terminals 100 in the radio system or between the user terminals 100 and an external network 126, 128, for example.

The main parts of a radio system are a core network 116, a base station system 1 10, a radio access network 130 and a user terminal 100. On a general level, the radio system can also be defined to comprise a user terminal, which is also known as a subscriber terminal and a mobile phone, for instance, and a network part, which comprises the fixed infrastructure of the radio system, i.e. the core network, radio access network and base station system.

The structure of the core network 116 corresponds to a combined structure of the GSM and GPRS systems. GSM network elements are responsible for establishing circuit-switched connections, and GPRS network elements are responsible for establishing packet-switched connections, some of the network elements being, however, used in both systems. A server 134 maintained by a service provider, such as an operator, controls the core network 116.

A mobile services switching centre (MSC) 118 is the centre point of the circuit-switched side of the core network 116. The same mobile services switching centre 118 can be used to serve the connections of both the radio access network 130 and the base station system 110. The tasks of the mobile services switching centre 118 include: switching, paging, user equipment location registration, handover management, collection of subscriber billing information, encryption parameter management, frequency allocation management, and echo cancellation.

Large core networks 116 may have a separate gateway mobile services switching centre (GMSC) 124, which takes care of circuit-switched connections between the core network 100 and external networks 128. An external network 128 can be for instance a public land mobile network (PLMN) or a public switched telephone network (PSTN).

A home location register (HLR) 136 contains a permanent subscriber register, i.e. the following information, for instance: an international mobile subscriber identity (IMSI), a mobile subscriber ISDN number (MSISDN), an authentication key, and when the radio system supports GPRS, a packet data protocol (PDP) address.

A serving GPRS support node (SGSN) 120 is the centre point of the packet-switched side of the core network 116. The main task of the serving GPRS support node 120 is to transmit and receive packets with the user equipment 100 supporting packet-switched transmission by using the radio access network 130 or the base station system 110. The serving GPRS support node 120 contains subscriber and location information related to the user terminal 100.

A gateway GPRS support node (GGSN) 122 is the packet-switched side counterpart of the gateway mobile services switching centre 124 of the circuit-switched side with the exception, however, that the gateway GPRS sup-port node 122 must also be capable of routing traffic from the core network 116 to external networks 126, whereas the gateway mobile services switching centre 124 only routes incoming traffic. In our example, the Internet represents external networks 126.

SMSC (Short Message Service Centre) is an element (not shown) through which short messages are transmitted and in which they can be stored for later transmission if the receiver is not reached, for example.

The base station system 110 comprises a base station controller (BSC) 114 and a base transceiver station (BTS) 112. The base station controller 114 controls the base transceiver station 112. The base station controller 114 takes care of the following tasks, for instance: radio resource management of the base transceiver station 112, intercell handovers, frequency control, i.e. frequency allocation to the base transceiver station 112, management of frequency hopping sequences, time delay measurement on the uplink, implementation of the operation and maintenance interface, and power control.

The radio access network 130 comprises a radio network subsystem 132. The radio network subsystem is either the full part or only the access part of a UMTS terrestrial radio access network (UTRAN), providing allocation and release of specific radio resources to establish means of connection between the user terminal 100 and the UTRAN.

The user terminal 100 is e.g. a mobile phone or another device including telecommunication means. The user terminal 100 contains at least one transceiver for establishing a radio link 104, 106 to the radio access network 130 or base station system 110. The user terminal 100 may also comprise the possibility of employing short-range communication; such as a transmitter-receiver function implemented using for example a Bluetooth chip, or an infrared or a WLAN connection. In addition, the user terminal 100 contains an antenna, a user interface and a battery.

USSD (Unstructured Supplementary Service Data) is a technology in GSM (Global System for Mobile Communications) radio systems. USSD supports transmitting information over the signalling channels of the GSM network and provides session-based communication enabling a variety of applications. USSD is defined within the GSM standard. USSD commands are routed back to the home mobile network's HLR 136. SIM Application Tool-kit and Wireless Application Protocol also support USSD.

In operation, USSD is used to send messages between the user terminal 100 and some external systems, such an application server 142. The MSC 118 connects through to the HLR 136 in the home network via an SS7 network, for example. The HLR 136 routes a request to a USSD Gateway 140, which in turn routes the request to the application server 142. The application server 142 may provide feedback through the same path to the serving MSC in the visited network. Routing to the applications is achieved via a simple service code, which is included in the USSD message. The interpretation of the service code may be achieved by configuration of the USSD Gateway 140 and by the actions of the external applications to which the service code relates.

Messages can be exchanged with the HLR 136, thus, the user terminal 100 may send USSD messages back to the home network even when it is roaming in other networks. The USSD gateway 140 is capable of supporting multiple external applications. USSD messages may be formatted in different ways. It may be defined what different parts of a message mean. A Personal Identification Number may be included in the USSD messages for security reasons. In addition to forwarding the USSD message to the external application server 142, the USSD Gateway 140 may also send the user terminal's 100 MSISDN, the number of the HLR 136 that handled the USSD message and the user terminal's 100 IMSI number. The USSD Gateway 140 thus provides external applications with sufficient information to perform a wide range of enhanced services. The USSD messages are communicated to the external application servers 142 via an interface with data communications over TCP/IP, for example. The external applications can be on any machine reachable by a TCP/IP network. The USSD Gateway 140 may forward requests and return back immediate responses, but the external applications may also submit Short Messages containing more information.

In order to communicate the current status and capabilities of the user terminal 100, a document that describes the user terminal 100 relative to some static baseline is needed. This kind of a document defines the current state of the user terminal 100. The USSD is an ideal communication channel for this type of information. Information that tells what capabilities are associated with a certain IMSI and IMEI combination communicates similar status information for a different application space.

In an embodiment of the invention, the user terminal 100 of the radio system is configured to generate a USSD (Unstructured Supplementary Service Data) message comprising data relating to parameters of the user terminal 100 and to transmit the USSD message to the HLR 136. The USSD message is routed to the HLR 136 of the user terminal 100 in accordance with the GSM recommendations, for example. The HLR 136 is configured to forward the USSD message via the USSD Gateway 140 to the application server 142. The USSD Gateway 140 communicates the USSD message to the application server 142 using TCP/IP, for example. The application server 142 is configured to process the USSD message for modifying the parameters of the user terminal 100. The application server 142 first interprets the USSD message and then performs the services indicated by the contents of the USSD message. The application server 142 may acknowledge a successful receipt of the USSD message to the user terminal 100 via the USSD Gateway 140. The application server 142 may also send further information to the user terminal 100 as a Short Message via an SMS (Short Message Service), for example.

In an embodiment of the invention, the data relating to parameters of the user terminal 100 comprises a request for configuration parameters and the application server 142 is configured to send configuration parameters to the user terminal 100 based on the received USSD message. It is also possible that the data relating to the parameters of the user terminal 100 comprises status information on the user terminal 100 and the application server 142 is configured to update the status information on the user terminal 100 based on the received USSD message. The status information may include static and dynamic information relating to the capabilities of the user terminal 100. The USSD message may also communicate information on accessories connected to the user terminal 100. It can also indicate what applications are available on the user terminal 100 even if they would not be activated when the USSD message is sent. The signalling of the basic status information may be quite similar to a known IMSI (international mobile subscriber identity) attach, for example. Information that indicates what capabilities are associated with a certain IMSI and IMEI combination communicates similar status information for a different application space.

The data relating to the parameters of the user terminal 100 may also be related to the user terminal configuration. For example, the user terminal 100 may request configuration information from the application server 142. This configuration information may be used to configure both applications as well as connectivity (to data services, for example). The configuration parameters may also be used to configure accessories connected to the user terminal 100. The actual configuration message may be delivered within a USSD transport channel. The USSD is better protected than SMS by the generic infrastructure of the radio network.

FIG. 2 shows an example of a user terminal 100. In an embodiment of the invention, the user terminal 100 comprises generating means for generating a USSD (Unstructured Supplementary Service Data) message, the USSD message comprising data relating to the parameters of the user terminal 100. The user terminal 100 also comprises transceiver means for transmitting the USSD message to an application server of the radio system and for receiving feedback from the application server, and modifying means 214 for modifying the parameters of the user terminal 100.

The generating means for generating the USSD message may include a control unit 202 and a user interface 208, for example. The control unit 202, typically implemented by means of a microprocessor and software or separate components, controls the basic functions of the user terminal 100. The user interface 208 of the user terminal 100 may comprise a display, a loudspeaker and a keypad part. Depending on the type of the user terminal 100, there may be different and a different number of user interface parts. The user of the user terminal 100 may, for example, use the user interface 208 to key in a digit string that forms the USSD message. It is also possible that the digit strings forming different USSD messages are stored under abbreviated dial keys on the user interface 208.

The transceiver means for transmitting the USSD message and receiving feedback from external systems, such as from the application server, include means 204 known in the art that implement the functions of a mobile station and include speech and channel coders, modulators and RF parts. The transceiver means may also comprise an antenna 206.

The user terminal 100 may comprise a SIM (Subscriber Identity Module) card 212; a smart card that contains security related information, subscriber related information and algorithms. Also, files containing varying information, such as phone numbers and short messages (SMS, Short Message Service), can be stored in the SIM card 212. The user terminal 100 also comprises a memory 210. The memory 210 may be in the SIM card 212, for example.

In an embodiment of the invention, the modifying means 214 have been used for modifying parameters of the user interface 100. It is possible that the generated USSD message comprises data relating to the modified parameters of the user terminal 100. The data relating to parameters of the user terminal 100 may comprise status information on the user terminal 100, the status information including static and dynamic information relating to the capabilities of the user terminal 100, for example.

In another embodiment of the invention, the data relating to parameters of the user terminal 100 comprises a request for configuration parameters and the received feedback comprises the requested configuration parameters. The modifying means 214 are configured to modify the paramerers of the user terminal 100 based on the configuration parameters received from an external system, such as an application server.

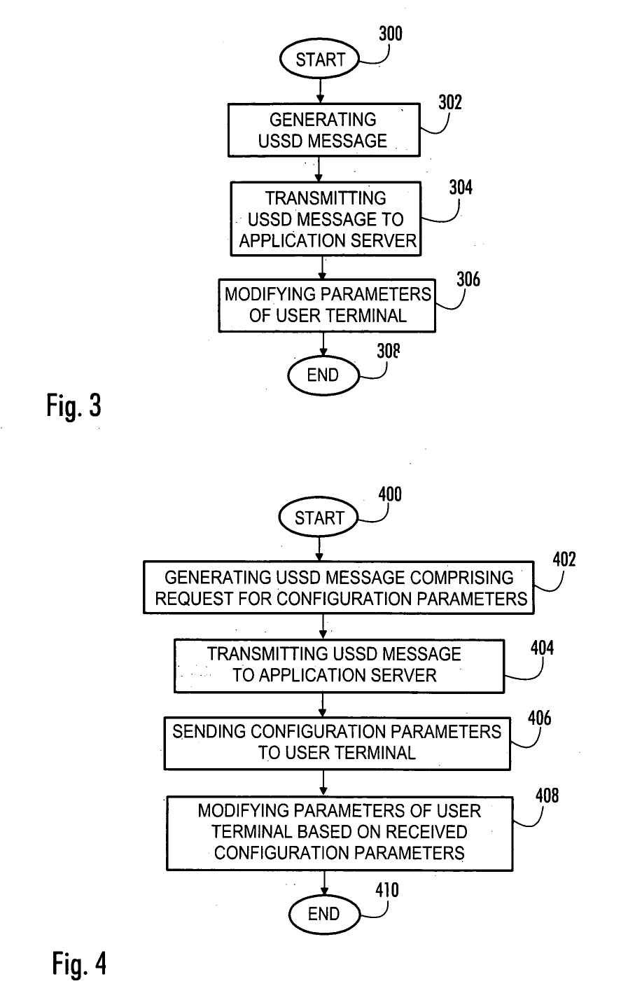

FIG. 3 shows an example of a method of modifying parameters of a user terminal in the radio system. The method starts in 300. The method may be used whenever the user terminal is switched on, for example. A user of the user terminal may have added new accessories to the user terminal, for example; therefore; the status of the user terminal has changed. In order to inform the radio system about the change, a USSD message is generated in the user terminal in 302. The USSD message comprises status information, such as static and dynamic information relating to the user terminal, for example. In 304, the user terminal transmits the generated USSD message via the home location register of the user terminal and a USSD Gateway to an application server. After the USSD message is received by the application server, it is processed. In 306, the application server based on the USSD message modifies the parameters of the user terminal in question. The method ends in 308.

FIG. 4 shows another example of a method of modifying parameters of a user terminal in the radio system. The method starts in 400. In this example, a need exists for configuration parameters for an application in the user terminal. The configuration parameters may be requested from an external system, such as an application server, by using the method. In 402, a USSD message is generated in the user terminal. The USSD message-comprises a request for the configuration parameters needed. In 404, the USSD message is transmitted to the application server via the home location register of the user terminal and the USSD Gateway. After the application server has received and interpreted the USSD message the process enters step 406, where the application server may send the requested configuration parameters to the user terminal. In 408, the parameters of the user terminal may be modified based on the received configuration parameters. The method ends in 410.

The embodiments of the invention may also be used to tunnel information typically transported over IP based bearers. An example of such a service is DHCP (dynamic host configuration protocol). The user terminal may use the method to communicate a CHCP-style request to a DHCP proxy that acts as a middleman towards DHCP servers.

Even though the invention has been described above with reference to the examples according to the accompanying drawings, it is clear that the invention is not restricted thereto but can be modified in several ways within the scope of the appended claims.

1. A method of modifying parameters of a user terminal in a radio system, the method comprising:
generating a USSD (Unstructured Supplementary Service Data) message comprising data relating to parameters of the user terminal;
transmitting the USSD message from the user terminal to a home location register of the radio system;
forwarding the received USSD message from the home location register via a USSD gateway to an application server; and
modifying the parameters of the user terminal based on the data relating to the parameters of the user terminal.

2. The method of claim 1, wherein the data relating to the parameters of the user terminal comprises a request for configuration parameters, and the method further comprises sending, by the application server, configuration parameters to the user terminal based on the received USSD message.

3. The method of claim 1, wherein the data relating to the parameters of the user terminal comprises status information on the user terminal, and the step of modifying the parameters of the user terminal comprises updating the status information on the user terminal.

4. The method of claim 3, wherein the status information is static and dynamic information relating to capabilities of the user terminal.

5. A radio system comprising a user terminal, a home location register, a USSD gateway and an application server, wherein:
the user terminal is configured to generate a USSD (Unstructured Supplementary Service Data) message comprising data relating to parameters of the user terminal and to transmit the USSD message to the home location register;
the home location register is configured to forward the USSD message via the USSD gateway to the application server; and
the application server is configured to process the USSD message for modifying the parameters of the user terminal.

6. The radio system of claim 5, wherein the data relating to the parameters of the user terminal comprises a request for configuration parameters and the application server is configured to send configuration parameters to the user terminal based on the received USSD message.

7. The radio system of claim 5, wherein the data relating to the parameters of the user terminal comprises status information on the user terminal, and the application server is configured to update the status information on the user terminal based on the received USSD message.

8. The radio system of claim 7, wherein the status information is static and dynamic information relating to capabilities of the user terminal.

9. A user terminal in a radio system, the user terminal comprising:
generating means for generating a USSD (Unstructured Supplementary Service Data) message, the USSD message comprising data relating to parameters of the user terminal;
transceiver means for transmitting the USSD message to an application server of the radio system and for receiving feedback from the application server; and
modifying means for modifying the parameters of the user terminal.

10. The user terminal of claim 9, wherein the generating means are configured to generate the USSD message based on the modified parameters of the user terminal.

11. The user terminal of claim 10, wherein the data relating to the parameters of the user terminal comprises status information on the user terminal, the status information including static and dynamic information relating to capabilities of the user terminal.

12. The user terminal of claim 9, wherein the data relating to the parameters of the user terminal comprises a request for configuration parameters, the received feedback comprises the requested configuration parameters, and the modifying means are configured to modify the parameters of the user terminal based on the received configuration parameters from the application server.
